(19) United States
(12) Patent Application Publication
(10) Pub. No.: US 2014/0201011 A1
(43) Pub. Date: Jul. 17, 2014

(54) ORDER PROCESSING SYSTEM, ORDER ENTORY TERMINAL AND ORDERING METHOD

(71) Applicant: TOSHIBA TEC KABUSHIKI KAISHA, Tokyo (JP)

(72) Inventor: Kouichi Asai, Shizuoka-ken (JP)

(73) Assignee: TOSHIBA TEC KABUSHIKI KAISHA, Tokyo (JP)

(21) Appl. No.: 14/154,651

(22) Filed: Jan. 14, 2014

(30) Foreign Application Priority Data
Jan. 17, 2013 (JP) 2013-006430

(51) Int. Cl. G06Q 50/12; G06Q 30/06

(52) U.S. Cl. CPC G06Q 50/12; G06Q 30/0635
USPC 705/15

(57) ABSTRACT

In accordance with one embodiment, an order processing system comprises an ordering terminal equipped with an input/output section for inputting/outputting an order including a commodity name, a quantity and a serving order, a commodity database including a commodity name and a unit price for each commodity, an order file for storing the ordering quantity and the serving order for each ordered commodity, and a main control section which sends the next order according to the serving order to an order processing apparatus when the serving completion of the order just prior to the next order is input, and the order processing apparatus equipped with a cooking instruction file for storing the order received from the order entry terminal, and a control section which commands the output of a cooking instruction when the order is received.

### CROSS-REFERENCE TO RELATED APPLICATION

This application is based upon and claims the benefit of priority from Japanese Patent Application No. 2013-006430, filed Jan. 17, 2013, the entire contents of which are incorporated herein by reference.

### FIELD

Embodiments described herein relate to an order processing system, an order entry terminal and an ordering method.

### BACKGROUND

In recent years, an order processing system is being introduced to restaurants to register the order of a customer, give a cooking instruction to the kitchen and carry out a checkout processing.

For the sake of reducing the number of staffs and improving the quality of services, a self-order terminal is introduced to register an order with the operation by a customer.

The self-order terminal is an apparatus such as a so-called tablet terminal and the like, and on an input/output section of the apparatus, columns of ‘menu’, ‘unit price’ and ‘ordering quantity’ are displayed.

A customer selects desired menu, inputs quantities and gives a transmission instruction to send the order, using the self-order terminal.

The data of the order is sent to an order processing apparatus located at the kitchen. The order processing apparatus outputs a cooking instruction from a printer connected thereto to a cook.

However, in the conventional order processing system, there is a problem that it is difficult to manage a cooking order because too many orders are instructed to the cook at a time. Moreover, sometimes dishes are not orderly served as the customer expects.

### BRIEF DESCRIPTION OF THE DRAWINGS

FIG. 1 is a block diagram illustrating a constitution of an order processing system according to an embodiment;

FIG. 2 is a diagram illustrating a data constitution of a commodity database according to the embodiment;

FIG. 3 is a diagram illustrating a data constitution of an order file according to the embodiment;

FIG. 4 is a diagram illustrating a data constitution of a cooking instruction file according to the embodiment;

FIG. 5 is a flowchart illustrating operations of the order processing system according to the embodiment;

FIG. 6 is a diagram illustrating an example of an order input screen of an order entry terminal according to the embodiment; and

FIG. 7 is a diagram illustrating an example of a serving completion screen of the order entry terminal according to the embodiment.

### DETAILED DESCRIPTION

In accordance with one embodiment, there is provided an order processing system comprising an order entry terminal equipped with an input/output section for inputting/outputting an order including a commodity name, a quantity and a serving order, a commodity database including a commodity name and a unit price for each commodity, an order file for storing the ordering quantity and the serving order for each ordered commodity, and a main control section which sends the next order according to the serving order to an order processing apparatus when the serving completion of the order just prior to the next order is input; and the order processing apparatus equipped with a cooking instruction file for storing the order received from the order entry terminal, and a control section which commands the output of a cooking instruction when the order is received.

An embodiment of the order processing system, an order entry terminal and an ordering method is described in detail below with reference to the accompanying drawings.

The order processing system described herein comprises an order entry terminal and an order processing apparatus.

The order entry terminal comprises an input/output section for inputting/outputting information, a commodity database including a commodity name and a unit price for each commodity, an order file for storing an ordering quantity and a serving order for each ordered commodity, a communication section for carrying out communication and a main control section which sends the next order according to the serving order when the serving completion of the order just prior to the next order is input.

The order processing apparatus comprises a cooking instruction file for storing the order received from the order entry terminal, a communication section for carrying out communication and a control section which commands an output of a cooking instruction if an order is received.

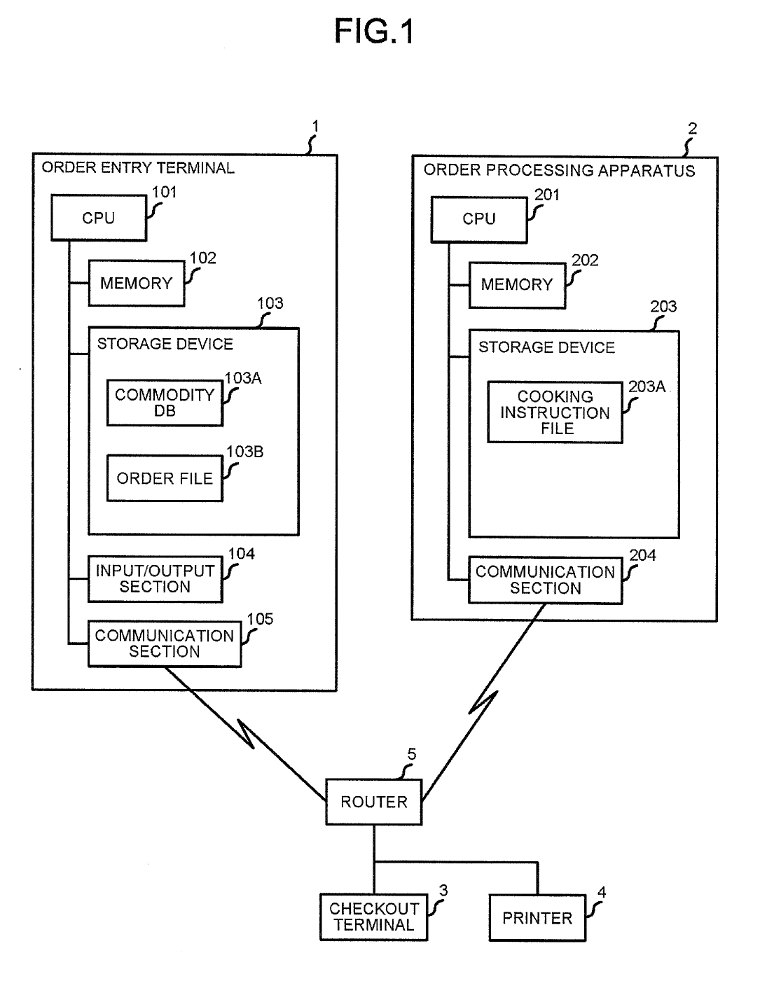

FIG. 1 is a block diagram illustrating the constitution of the order processing system. As shown in FIG. 1, the order processing system comprises the following components: an order entry terminal 1 configured to register orders of a customer and send the orders in a designated order; an order processing apparatus 2 configured to receive the orders and give an instruction to produce the ordered dish; a printer 4 configured to output the production instruction; a checkout terminal 3 configured to carry out a checkout processing; and a router 5 serving as an agent for receiving and sending the order.

The order entry terminal 1, which is, for example, a tablet type computer, comprises a CPU 101 serving as a main control section; a memory 102 such as a ROM, a RAM and the like; a non-volatile storage device 103 such as a flash ROM; an input/output section 104 serving as an input/output device such as a touch panel; and a communication section 105 for carrying out communication.

The storage device 103 of the order entry terminal 1 stores a commodity database (hereinafter referred to as a DB) 103A which includes a commodity name and a unit price for each commodity and an order file 103B for storing an ordering quantity, a serving table and a serving order for each ordered commodity.

The order processing apparatus 2, which is, for example, a personal computer, comprises a CPU 201 serving as a control section; a memory 202 such as a ROM, a RAM and the like; a non-volatile storage device 203 such as a flash ROM; and a communication section 204 for carrying out communication.

The storage device 203 of the order processing apparatus 2 stores a cooking instruction file 203A for storing an ordering quantity and a serving table for each ordered commodity.

The checkout terminal 3, which may be a POS register, comprises a calculation section for calculating a checkout amount, a drawer for depositing and dispensing cash, and a printer for printing a receipt.

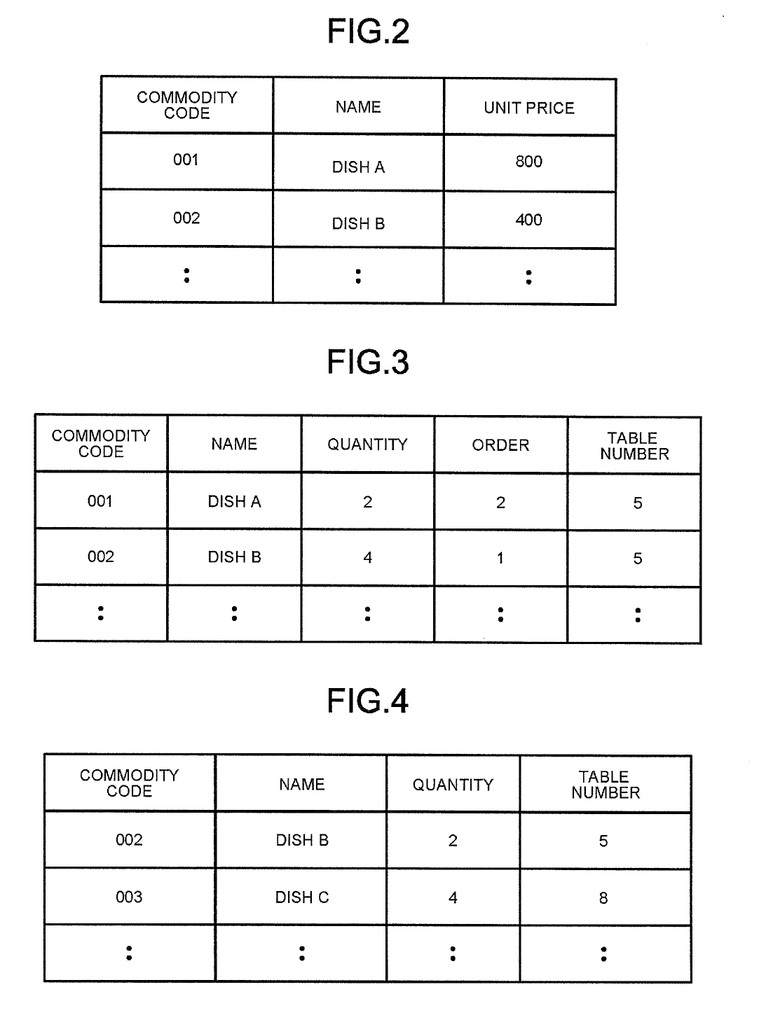

FIG. 2 is a diagram illustrating the data constitution of the commodity DB 103A. As shown in FIG. 2, the commodity DB 103A stores ‘commodity code’ uniquely assigned to each commodity, ‘name’ of each commodity and ‘unit price’ of each commodity.

As an example of each data, the commodity code is ‘001’, the name is ‘dish A’, and the unit price is ‘800’.

FIG. 3 is a diagram illustrating the data constitution of the order file 103B. As shown in FIG. 3, the order file 103B stores ‘commodity code’ uniquely assigned to each commodity, ‘name’ of each commodity, ‘quantity’ showing an ordering quantity, ‘order’ showing a customer-desired serving order and ‘table number’ showing the serving table.

As an example of each data, the commodity code is ‘001’, the name is ‘dish A’, the quantity is ‘2’, the order is ‘second’ and the table number is ‘5’.

FIG. 4 is a diagram illustrating the data constitution of the cooking instruction file 203A. As shown in FIG. 4, the cooking instruction file 203A stores ‘commodity code’ uniquely assigned to each commodity, ‘name’ of each commodity, ‘quantity’ showing an ordering quantity and ‘table number’ showing the serving table.

As an example of each data, the commodity code is ‘002’, the name is ‘dish B’ , the quantity is ‘2’ and the table number is ‘5’.

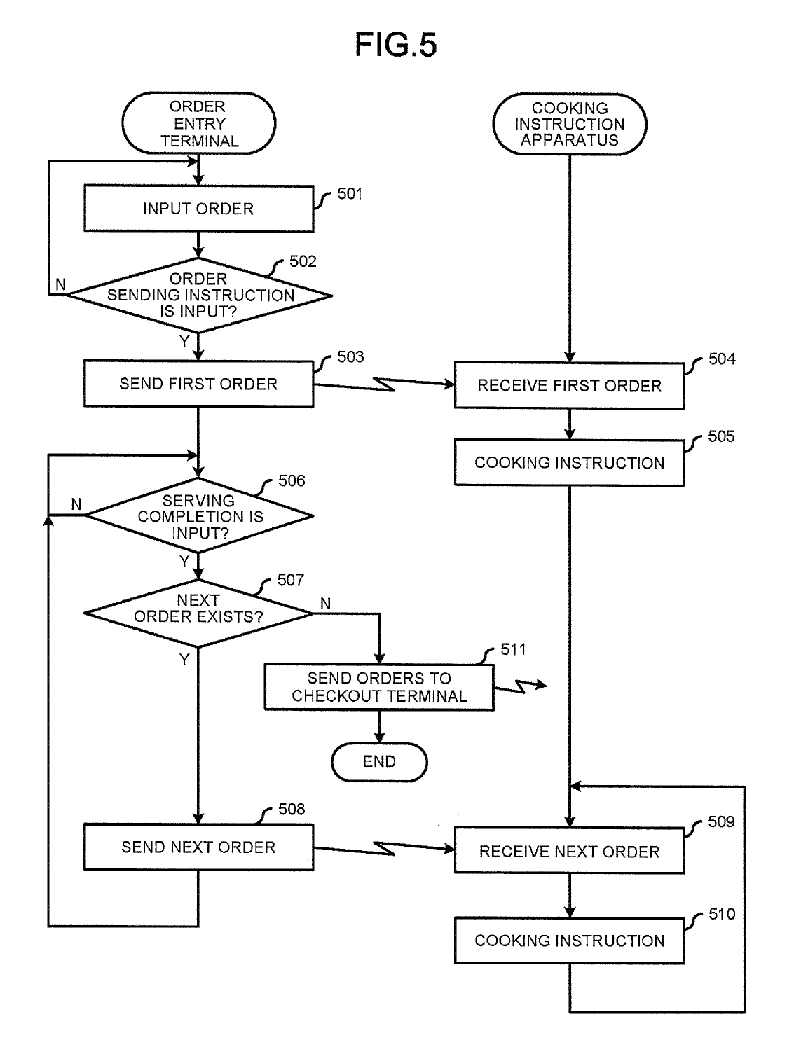

FIG. 5 is a flowchart illustrating the operations of the order processing system.

As shown in FIG. 5, the order entry terminal 1 receives the input of a customer-desired serving order when an order is input.

The order entry terminal 1 sends the first order according to the serving order to the order processing apparatus 2 when an order sending instruction is input.

The second and the following orders according to the serving order are sent in the order to the order processing apparatus 2 when the serving completion of the order sent immediately before a next order is sent is registered by the operator.

The operations are described below with reference to the flowchart.

In ACT 501, the order entry terminal 1 receives input of an order. The order entry terminal 1 first displays a menu on the input/output section 104 with reference to the commodity DB 103A. A customer inputs an order to the order entry terminal 1. The order contains a commodity code or a commodity name serving as an identifier for identifying a commodity to be ordered, an ordering quantity and a customer-desired serving order. The order entry terminal 1 stores the input order in the order file 103B.

In ACT 502, the order entry terminal 1 determines whether or not an order sending instruction is input. If the order entry terminal 1 determines that an order sending instruction is input, ACT 503 is taken, otherwise, ACT 501 is taken.

In ACT 503, the order entry terminal 1 reads the order file 103B and sends the first order according to the serving order to the order processing apparatus 2.

In ACT 504, the order processing apparatus 2 receives the first order according to the serving order and stores the order in the cooking instruction file 203A.

In ACT 505, the order processing apparatus 2 reads the first order from the cooking instruction file 203A and outputs the order from the printer 4 as a cooking instruction.

In ACT 506, the order entry terminal 1 determines whether or not the serving completion is input. If the order entry terminal 1 determines that the serving completion is input, ACT 507 is taken, otherwise, ACT 506 is taken.

In ACT 507, the order entry terminal 1 reads the order file 103B and determines whether or not there is a next order. If the order entry terminal 1 determines that there is a next order, ACT 508 is taken, otherwise, ACT 511 is taken.

In ACT 508, the order entry terminal 1 reads the order file 103B and sends the next order according to the serving order to the order processing apparatus 2.

In ACT 509, the order processing apparatus 2 receives the next order according to the serving order and stores the order in the cooking instruction file 203A.

In ACT 510, the order processing apparatus 2 reads the next order from the cooking instruction file 203A and outputs the order from the printer 4 as a cooking instruction, and then ACT 509 is taken.

In ACT 511, the order entry terminal 1 sends all the orders of the customer in the table to the checkout terminal 3 and ends the processing.

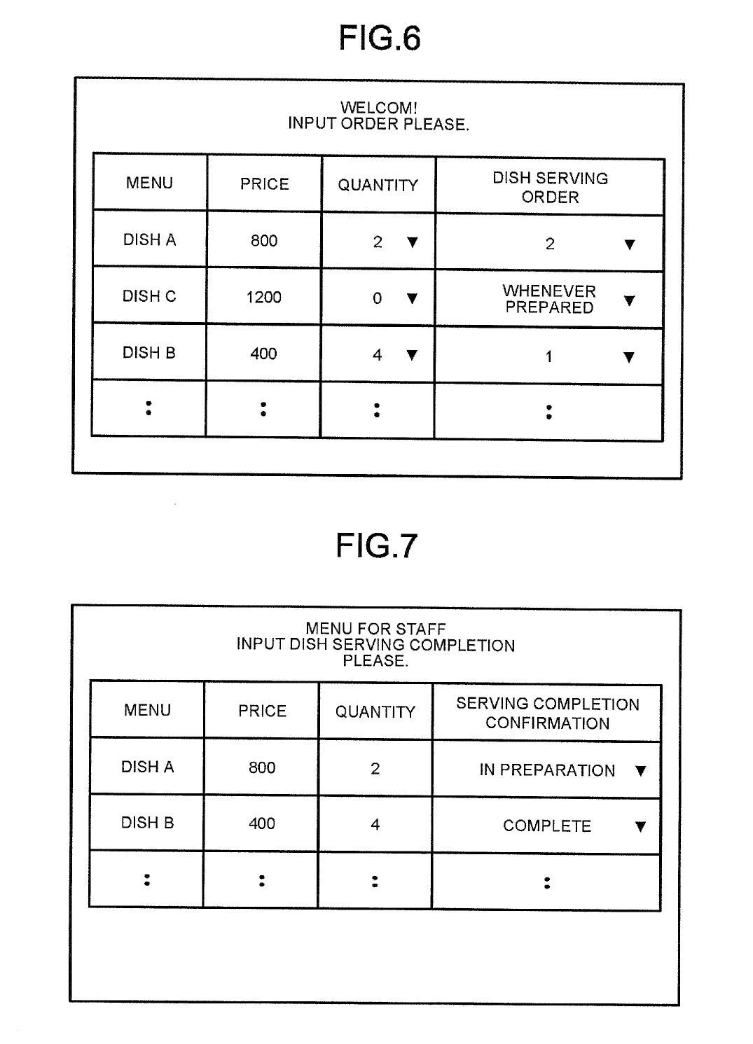

FIG. 6 is a diagram illustrating an example of the order input screen of the order entry terminal 1. As shown in FIG. 6, the order entry terminal 1 displays, for each commodity, ‘menu’ showing a commodity name, ‘price’ showing a unit price, ‘quantity’ showing an ordering quantity and ‘dish serving order’ showing a customer-desired serving order on the order input screen for the customer.

The quantity and the dish serving order may be input, using a pull-down menu.

FIG. 7 is a diagram illustrating an example of the serving completion screen of the order entry terminal 1. As shown in FIG. 7, the order entry terminal 1 displays, on the serving completion screen for the operator, ‘menu’ showing a commodity name, ‘price’ showing a unit price and ‘quantity’ showing an ordering quantity, as an order content; and a serving completion confirmation column is displayed for each detail of the order.

The serving completion confirmation column may be arranged to select one from ‘not-yet-instructed’, ‘cooking’ and ‘serving completion’ using a pull-down menu.

As stated above, in accordance with the present embodiment, an order processing system comprises an order entry terminal 1 equipped with an input/output section for inputting/outputting an order including a commodity name, a quantity and a serving order, a commodity DB 103A including a commodity name and a unit price for each commodity, an order file 103B for storing the ordering quantity and the serving order for each ordered commodity, and a control section which sends the next order according to the serving order when the serving completion of the order just prior to the next order is input, and an order processing apparatus 2 equipped with a cooking instruction file 203A for storing the received order, and a control section which instructs the output of a cooking instruction when an order is received.

Thus, ordered items can be received according to a customer-desired serving order, and a cooking instruction can be timely output to a person who makes or produces the ordered items.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An order processing system, comprising:
an order entry terminal including an input/output section configured to input/output an order including a commodity name, a quantity and a serving order, a commodity database configured to have a commodity name and a unit price for each commodity, an order file configured to store the ordering quantity and the serving order for each ordered commodity, and a main control section configured to send the next order according to the serving order to an order processing apparatus when the serving completion of the order just prior to the next order is input; and
the order processing apparatus including a cooking instruction file configured to store the order received from the order entry terminal, and a control section configured to command the output of a cooking instruction when the order is received.

2. The order processing system according to claim 1, wherein the main control section sends all the orders of each customer in a serving table to a checkout terminal if it is determined that the serving completion of all the orders in the serving table is input.

3. An order entry terminal, comprising:
an input/output section configured to input/output an order including a commodity name, a quantity and a serving order;
a commodity database configured to have a commodity name and a unit price for each commodity;
an order file configured to store the ordering quantity and the serving order for each ordered commodity; and
a main control section configured to send the next order according to the serving order to an order processing apparatus which gives a cooking instruction when the serving completion of the order just prior to the next order is input.

4. The order entry terminal according to claim 3, wherein the main control section sends all the orders of each customer in a serving table to a checkout terminal if it is determined that the serving completion of all the orders in the serving table is input.

5. An ordering method by an order entry terminal comprising an input/output section, a commodity database having a commodity name and a unit price for each commodity, and an order file, including:
receiving an order including a commodity name, a quantity and a serving order;
reading the unit price of the ordered commodity name from the commodity database;
storing the ordering quantity and the serving order for each ordered commodity input from the input/output section in the order file; and
sending the next order according to the serving order to an order processing apparatus which gives a cooking instruction when the serving completion of the order just prior to the next order is input.

6. The ordering method according to claim 5, wherein all the orders of each customer in a serving table are sent to a checkout terminal if it is determined that the serving completion of all the orders in the serving table is input.
